(19) United States
(12) Patent Application Publication
(10) Pub. No.: US 2024/0428104 A1
(43) Pub. Date: Dec. 26, 2024

(54) QUBIT SHARING ACROSS SIMULTANEOUS QUANTUM JOB AND/OR TRAINED MODEL EXECUTION

(71) Applicant: International Business Machines Corporation, Armonk, NY (US)

(72) Inventors: John S. Werner, Fishkill, NY (US); Vladimir Rastunkov, Mundelein, IL (US); Frederik Frank Flöther, Schlieren (CH)

(21) Appl. No.: 18/213,186

(22) Filed: Jun. 22, 2023

(51) Int. Cl. G06N 10/20; G06N 10/40

(52) U.S. Cl. CPC G06N 10/20; G06N 10/40

(57) ABSTRACT

A method, system, and computer program product for qubit sharing across simultaneous quantum job and/or model execution. Qubit groups within quantum jobs and/or trained models that match with respect to a starting state and a gate structure are identified. Furthermore, qubit groups that are considered for dynamic quantum job and/or model reset and reuse for another computation during a simultaneous quantum job and/or model execution are identified. Based on such identified qubit groups, a record of potential quantum job and/or model minimizations is created. A potential quantum job and/or model minimization is removed one at a time from the record until the quantum jobs and/or models can be positioned on the coupling map. Once that occurs, single compressed quantum jobs and/or models are generated that each use two or more quantum jobs and/or models that can share qubits based on the current record of potential quantum job and/or model minimizations.

### TECHNICAL FIELD

The present disclosure relates generally to quantum computing, and more particularly to minimizing the total number of qubits used on a quantum processor, increasing qubit utilization, and reducing idle qubits on each processor run by sharing qubits across simultaneous quantum job and/or trained model execution.

### BACKGROUND

Quantum computing is a rapidly-emerging technology that harnesses the laws of quantum mechanics to solve problems too complex for classical computers. Quantum computing is a type of computation that harnesses the collective properties of quantum states, such as superposition, interference, and entanglement, to perform calculations. The devices that perform quantum computations are known as quantum computers. Though current quantum computers are too small to outperform usual (classical) computers for practical applications, they are believed to be capable of solving certain computational problems, such as integer factorization, substantially faster than classical computers.

### SUMMARY

In one embodiment of the present disclosure, a method for qubit sharing across simultaneous quantum job and/or model execution comprises identifying qubit groups within a plurality of quantum jobs and/or models that match with respect to a starting state and a gate structure. The method further comprises identifying qubit groups from separate quantum jobs and/or models of the plurality of quantum jobs and/or models that are considered for dynamic quantum job and/or model reset and reuse for another computation during a same simultaneous quantum job and/or model execution. The method additionally comprises creating a record of potential quantum job and/or model minimizations based on the identification of the matching qubit groups and the identification of the qubit groups that are considered for dynamic quantum job and/or model reset and reuse. Furthermore, the method comprises generating a single compressed quantum job and/or model using two or more quantum jobs and/or models of the plurality of quantum jobs and/or models that can share qubits based on a current record of potential quantum job and/or model minimizations. Additionally, the method comprises positioning the single compressed quantum job and/or model on a coupling map.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the internal structure of the quantum computing device in accordance with an embodiment of the present disclosure;

FIG. 3 illustrates an embodiment of the present disclosure of the hardware configuration of the orchestration server which is representative of a hardware environment for practicing the present disclosure;

FIG. 4 is a flowchart of a method for comparing quantum jobs and/or trained models to determine if there are matching qubits or qubit groups that have the same starting state and perform the same function in accordance with an embodiment of the present disclosure;

FIGS. 5A-5B illustrate a matching qubit group in accordance with an embodiment of the present disclosure;

FIGS. 6A-6B are a flowchart of a method for generating a minimized quantum job and/or trained model based on various factors in accordance with an embodiment of the present disclosure;

FIGS. 7A-7B illustrate combining multiple quantum jobs and/or trained models into a quantum job and/or trained model that utilizes fewer qubits in accordance with an embodiment of the present disclosure; and

FIG. 8 illustrates positioning a single compressed quantum job and/or model on a coupling map in accordance with an embodiment of the present disclosure.

### DETAILED DESCRIPTION

As stated in the Background section, quantum computing is a rapidly-emerging technology that harnesses the laws of quantum mechanics to solve problems too complex for classical computers. Quantum computing is a type of computation that harnesses the collective properties of quantum states, such as superposition, interference, and entanglement, to perform calculations. The devices that perform quantum computations are known as quantum computers. Though current quantum computers are too small to outperform usual (classical) computers for practical applications, they are believed to be capable of solving certain computational problems, such as integer factorization, substantially faster than classical computers.

There are several types of quantum computers (also known as quantum computing systems), including the quantum circuit model, quantum Turing machine, adiabatic quantum computer, one-way quantum computer, and various quantum cellular automata. The most widely used model is the quantum circuit, based on the quantum bit, or “qubit,” which is somewhat analogous to the bit in classical computation. A qubit can be in a 1 or 0 quantum state, or in a superposition of the 1 and 0 states. When the state of the qubit is measured from the execution of the quantum circuit, however, it is always 0 or 1 where the probability of either outcome depends on the qubit's quantum state immediately prior to measurement. That is, the qubit state collapses into either the quantum state of 0 (represented as “|0 [symbol] ”) or the quantum state of 1 (represented as “|1 [symbol] ”).

Due to their superior modeling capacity, quantum computers will be increasingly used to simulate complex, composite objects, systems, and processes of the real world. Given the limited availability of quantum hardware, executing a large number of quantum jobs and/or trained models will require compartmentalization of tasks and simultaneous execution of quantum jobs and/or trained models on one or more processors. A quantum job refers to a unit of work or a unit of execution (that performs said work) involving a quantum task. A trained model refers to a quantum machine learning model that is an expression of an algorithm that has been trained to represent the actions of an object, environment, or person, where the model is represented as one or more quantum circuits.

These simultaneously running quantum jobs and/or trained models may be completely independent in some scenarios, and in other scenarios may involve computations that have interactions between the quantum jobs and/or trained models.

Examples of computations that have interactions between quantum jobs and/or trained models can relate to the metaverse, digital twins, and/or an augmented reality (AR) cloud.

Digital twins are virtual representations of a real-world object or process. Several technologies, including machine learning (ML)/artificial intelligence (AI), Internet of Things, and quantum computing are connected with and help accelerate progress in the field of digital twins.

One area of particular interest is the interactions between digital twins. As metaverses (a metaverse refers to any digital or virtual reality platform that combines any combination of aspects from online gaming, social media, virtual reality, augmented reality, cryptocurrencies, or non-fungible tokens for users to interact with one another) become a reality, it is foreseen that digital twins will increasingly need to communicate with one another.

For example, the digital twins of machinery in a factory may be impacted by digital twins of other machinery or by the digital twins representing the environment and factory workers.

In another example, in a metaverse where many users are virtually attending a sporting event, the quantum jobs and/or trained models representing other fans at the game may react similarly in some aspects and differently in others depending on what is happening in the game.

In either situation, it is possible that redundant calculations are occurring between the quantum jobs and/or trained models that are running simultaneously on the same quantum processor (e.g., Eagle, Osprey, Condor) or linked quantum processors on the same quantum computer (e.g., Flamingo, Heron, Kookaburra).

By the occurrence of such redundant calculations, qubits are being wasted which limits the number of quantum jobs and/or trained models that can be executed simultaneously.

The embodiments of the present disclosure provide the means for reducing the occurrence of redundant calculations by sharing qubits across simultaneous quantum job and/or trained model execution. In one embodiment of the present disclosure, matching qubit groups (single qubit or a group of two or more qubits that have a multi-qubit gate acting on them at any point in a quantum job and/or trained model) from separate quantum jobs and/or models with the same starting state and gate structure are identified. A “quantum job,” as used herein, refers to a unit of work or a unit of execution (that performs said work) involving a quantum task. A “trained model” (or simply referred to herein as “model”), as used herein, refers to a quantum machine learning model that is an expression of an algorithm that has been trained to represent the actions of an object, environment, or person, where the model is represented as one or more quantum circuits. Also, qubit groups that can be considered for dynamic quantum job and/or model reset and reuse for another computation during the same simultaneous quantum job and/or trained model execution based on circuit depth are identified. Upon identifying such qubit groups, a record of potential quantum job and/or model minimizations based on such identified qubit groups is created. A determination is then made as to whether the quantum jobs and/or trained models can be placed on a coupling map (a connectively pattern and physical layout of the qubits in the quantum processor that determines which qubits can interact directly with each other, such as via a two-qubit gate) with the current record of potential quantum job and/or model minimizations. If not, then a potential quantum job and/or model minimization is removed one at a time from the record until all the quantum jobs and/or trained models can be positioned on the coupling map. Once the quantum jobs and/or trained models can be positioned on the coupling map, one or more single compressed quantum jobs and/or models are generated that each use two or more quantum jobs and/or trained models that can share qubits based on the current record of potential quantum job and/or model minimizations. The single compressed quantum job(s) and/or model(s) are then positioned on the coupling map along with the other quantum jobs and/or models that cannot share qubits and have no quantum job and/or model changes. As a result of the foregoing, the total number of qubits used on a quantum processor is minimized, the qubit utilization is increased, idle qubits on each processor run are reduced and repeating of the same computation is prevented. In one embodiment, the principles of the present disclosure are implemented on any combination of quantum jobs and/or models running simultaneously on a single quantum system which may or may not be interacting with each other. These and other features will be discussed in greater detail below.

While the following discusses the present disclosure in connection with qubits, the principles of the present disclosures may apply to any qudit (quantum dit) which is the unit of quantum information described by a superposition of d states, where the number of states is an integer greater than two. A person of ordinary skill in the art would be capable of applying the principles of the present disclosure to such implementations. Furthermore, embodiments applying the principles of the present disclosure to such implementations would fall within the scope of the present disclosure.

Furthermore, although the present disclosure discusses combining qubit groups that are within a quantum job and/or trained model, the principles of the present disclosure may apply to qubit groups being shared from quantum circuits across one or more separate quantum jobs and/or models. A person of ordinary skill in the art would be capable of applying the principles of the present disclosure to such implementations. Furthermore, embodiments applying the principles of the present disclosure to such implementations would fall within the scope of the present disclosure.

In some embodiments of the present disclosure, the present disclosure comprises a method, system, and computer program product for qubit sharing across simultaneous quantum job and/or model execution. In one embodiment of the present disclosure, qubit groups within quantum jobs and/or trained models that match with respect to a starting state and a gate structure are identified. A “quantum job,” as used herein, refers to a unit of work or a unit of execution (that performs said work) involving a quantum task. A “trained model” (or simply referred to herein as “model”), as used herein, refers to a quantum machine learning model that is an expression of an algorithm that has been trained to represent the actions of an object, environment, or person, where the model is represented as one or more quantum circuits. A qubit group corresponds to a single qubit if the qubit is never entangled with another qubit through the entire quantum job and/or trained model or a group of two or more qubits that has a multi-qubit gate acting on the qubits at any point in the quantum job and/or trained model. The starting state, as used herein, refers to the initial state. The gate structure, as used herein, refers to the quantum logic gates. Furthermore, qubit groups from separate quantum jobs and/or models that are considered for dynamic quantum job and/or model reset and reuse for another computation during a same simultaneous quantum job and/or model execution in which a depth of the qubit groups from separate quantum jobs and/or models plus a qubit reset time is less than a depth of the longest qubit group of all the quantum jobs and/or trained models are identified. Upon identifying such qubit groups, a record of potential quantum job and/or model minimizations based on such identified qubit groups is created. A determination is then made as to whether all the quantum jobs and/or trained models can be placed on a coupling map (a connectively pattern and physical layout of the qubits in the quantum processor that determines which qubits can interact directly with each other, such as via a two-qubit gate) with the current record of potential quantum job and/or model minimizations. If not, then a potential quantum job and/or model minimization is removed one at a time from the record until all the quantum jobs and/or trained models can be positioned on the coupling map. Once the quantum jobs and/or trained models can be positioned on the coupling map, one or more single compressed quantum jobs and/or trained models are generated that each use two or more quantum jobs and/or trained models that can share qubits based on the current record of potential quantum job and/or model minimizations. The single compressed quantum job(s) and/or trained model(s) are then positioned on the coupling map along with the other quantum jobs and/or trained models that cannot share qubits and have no quantum job and/or model changes. In this manner, the occurrences of redundant calculations are reduced by sharing qubits across simultaneous quantum job and/or trained model execution.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

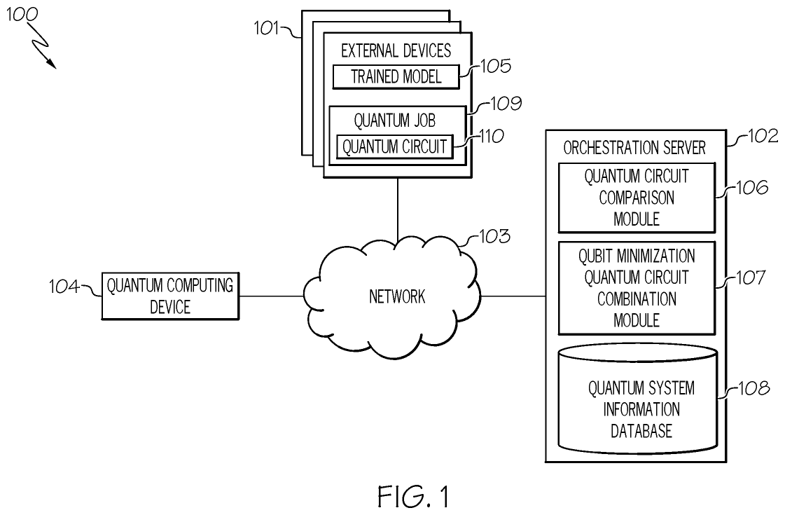

Referring now to the Figures in detail, FIG. 1 illustrates an embodiment of the present disclosure of a communication system 100 for practicing the principles of the present disclosure. In particular, communication system 100 includes the components of a system for allowing qubit sharing across simultaneous quantum job and/or model execution which is useful in various applications, such as running simultaneous metaverse entities, digital twins, and AR cloud entities.

A model (or “trained model”), as used herein, refers to a quantum machine learning model that is an expression of an algorithm that has been trained to represent the actions of an object, environment, or person, where the model is represented as one or more quantum circuits. A metaverse, as used herein, refers to any digital or virtual reality platform that combines any combination of aspects from online gaming, social media, virtual reality, augmented reality, cryptocurrencies, or non-fungible tokens for users to interact with one another. A digital twin, as used herein, refers to a virtual representation of a real-world physical asset of a system, which is continuously updated. An AR cloud, as used herein, provides an abstracted medium for physical spaces, objects, and humans where digital content and experiences can be tailored for every user.

As shown in FIG. 1, communication system 100 includes external devices 101 connected to an orchestration server 102 via a network 103. Furthermore, as shown in FIG. 1, quantum computing device 104 is connected to orchestration server 102 via network 103.

External devices 101, as used herein, refer to any electronic device that connects to orchestration server 102 and quantum computing device 104, such as a smartphone, a laptop, a tablet, a server, an augmented reality headset, a virtual reality headset, etc.

In one embodiment, external devices 101 connect to quantum computing device 104 and orchestration server 102 in a cloud computing environment.

In one embodiment, involving the implementation with digital twins, external devices 101 represent factory/manufacturing equipment, components within a supply chain, components of a larger integrated system, etc.

In one embodiment, involving the implementation in the metaverse, external devices 101 represent user avatars, products, virtual environments (e.g., classrooms, working environments, stores), etc.

In one embodiment, external devices 101 include trained models 105, which are quantum machine learning models that have been trained to represent the actions of an object, environment, or person as discussed above. In one embodiment, external devices 101 may include a quantum job 109 which contains one or more quantum circuits 110 that a user may create and upload to a queue to run on a quantum system, such as quantum computing device 104. A “quantum job 109,” as used herein, refers to a unit of work or a unit of execution (that performs said work) involving a quantum task.

In one embodiment, trained models 105 are located in storage on orchestration server 102 or on another server connected to network 103.

In one embodiment, trained models 105 represent one or more objects, environments, or people.

In one embodiment, trained models 105 have been trained for operation across one or more external devices 101 (e.g., a single trained model was created for the interaction between two objects, each on their own external device 101).

In one embodiment, trained models 105 may have been trained on a second quantum computing device which is different from quantum computing device 104 and may have been trained independently from each other. For example, three external devices 101 may be smaller and use less qubits, have a different coupling map, different error/noise levels and/or a different coherence time. A coupling map, as used herein, refers to a connectively pattern and physical layout of the qubits in the quantum processor that determines which qubits can interact directly with each other, such as via a two-qubit gate. A coherence time, as used herein, refers to the duration of time to perform the operations before the information is lost in the qubits.

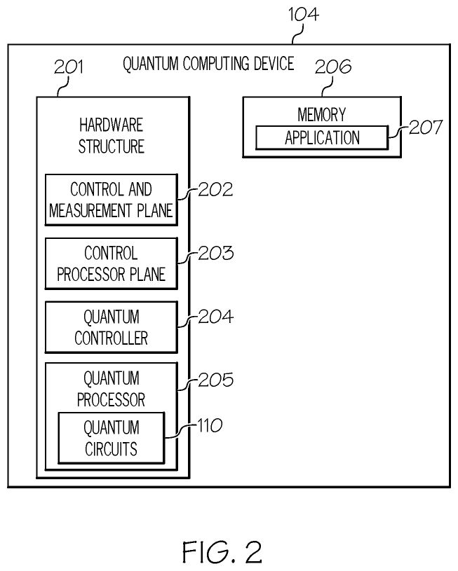

In one embodiment, quantum computing device 104 receives input from orchestration server 102, executes quantum circuits (representing trained models 105), sends its output back to orchestration server 102 which may forward the output back to external devices 101. A description of the internal structure of quantum computing device 104 is provided below in connection with FIG. 2.

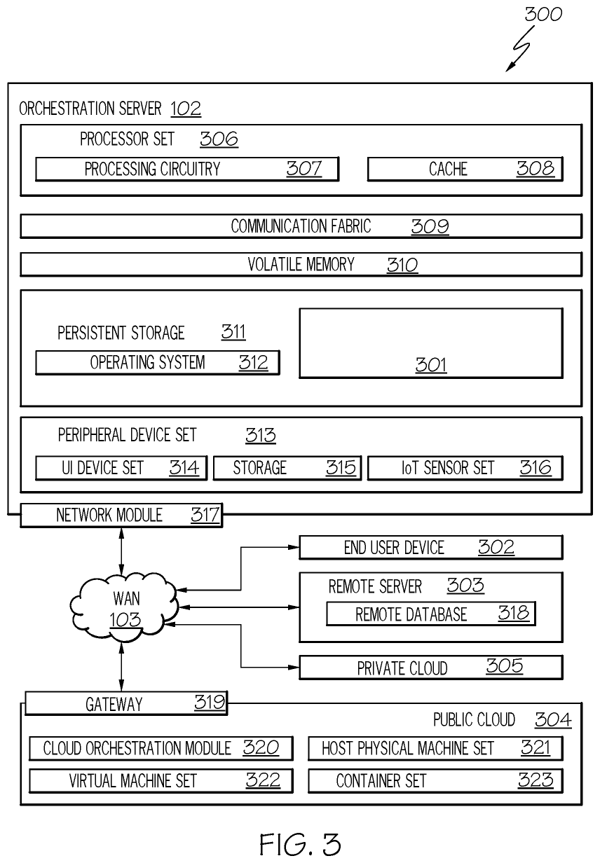

In one embodiment, orchestration server 102 contains the classical computing hardware required to run quantum circuit comparison module 106, qubit minimization quantum circuit combination module 107, and quantum system information database 108. A description of the hardware configuration of orchestration server 102 is provided further below in connection with FIG. 3. It is noted that any computations that occur within orchestration server 102 may also occur in a room temperature equipment (RTE), which contains classical computing hardware required to run quantum computing device 104.

In one embodiment, modules 106, 107 may run on any component within orchestration server 102, across multiple components within orchestration server 102, across multiple external components (not shown) within network 103 (e.g., cloud servers), or on room temperature electronics of quantum computing device 104.

In one embodiment, qubit minimization quantum circuit combination module 107 generates a minimized quantum job 109 and/or model 105 based on multiple factors, including, but not limited to, the output of quantum circuit comparison module 106, whether a qubit can be reset and reused for another computation in another quantum job 109 and/or model 105 in which the circuit depth (or longest execution time) of both computations plus the qubit reset time is less than the circuit dept of the longest qubit (or longest execution time) amongst all quantum jobs 109 and/or models 105, and quantum job and/or model placement to share one or more qubits on the coupling map.

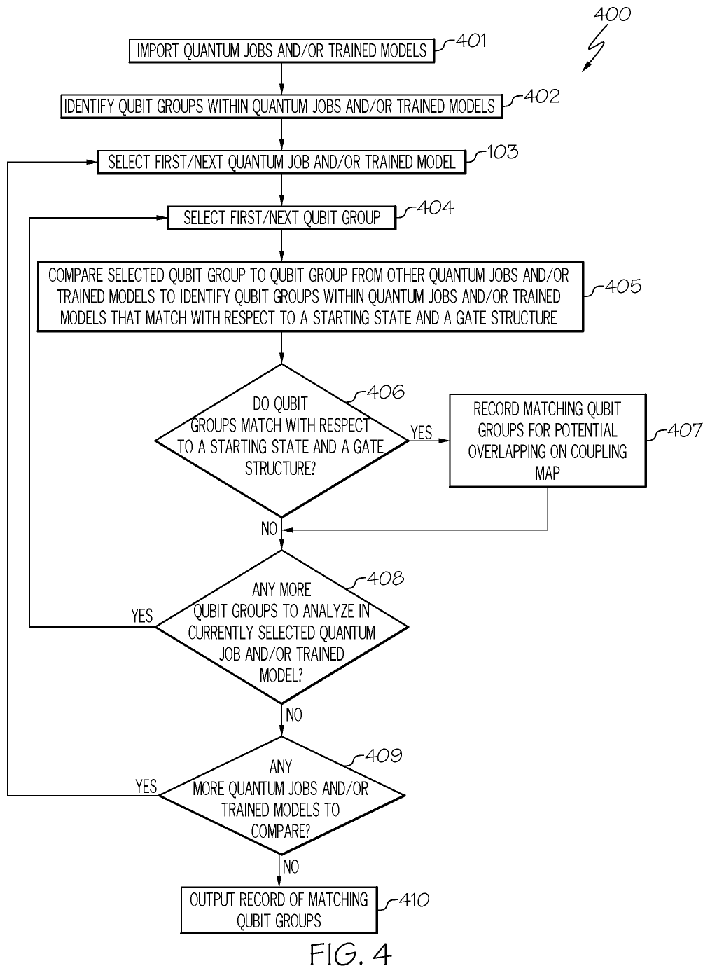

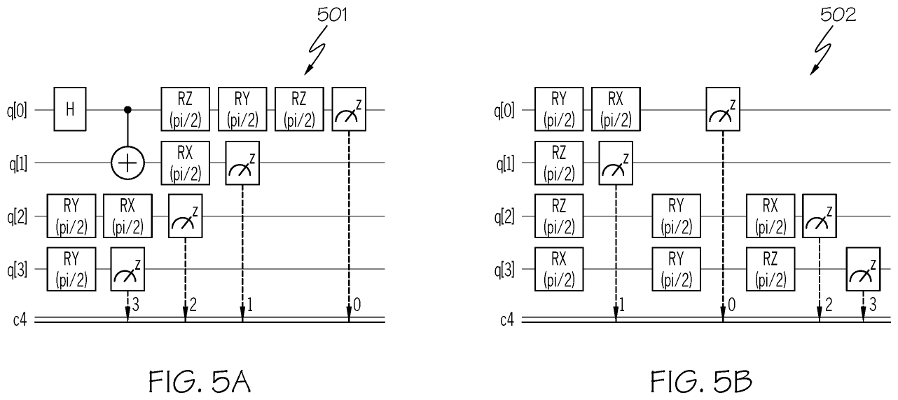

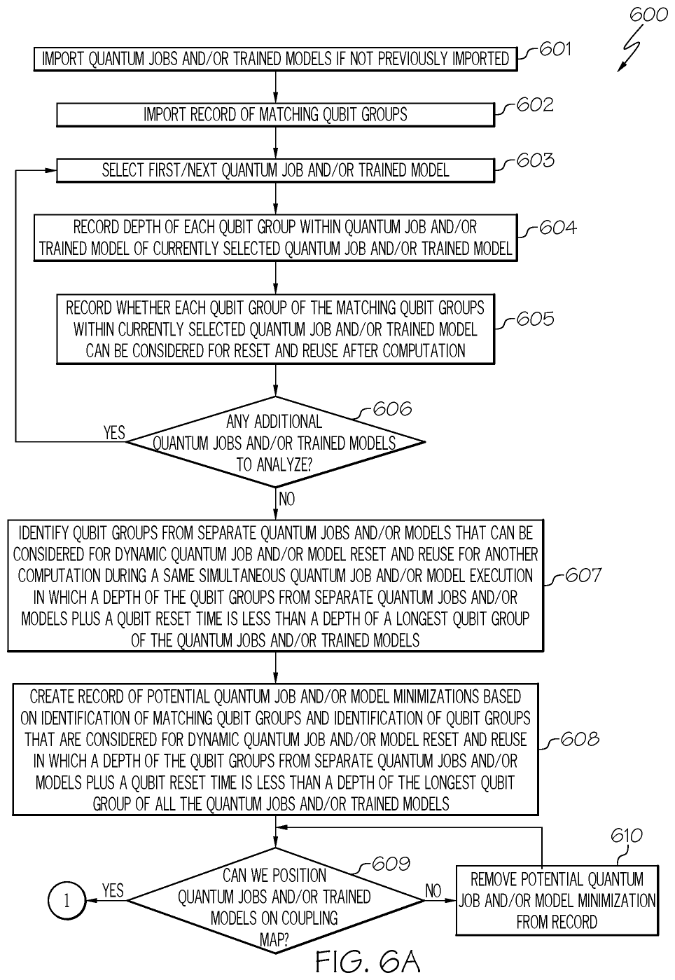

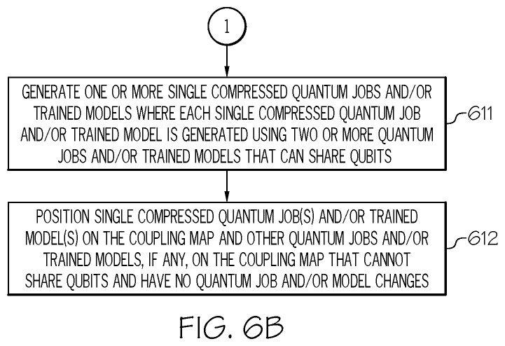

A discussion regarding the performance of quantum circuit comparison module 106 is provided below in connection with FIGS. 4 and 5A-5B. A discussion regarding the performance of qubit minimization quantum circuit combination module 107 is provided below in connection with FIGS. 6A-6B, 7A-7B and 8.

In one embodiment, quantum system information database 108 includes the type of quantum processor, coupling map, error/noise levels, coherence times, etc. of one or more quantum computing devices 104 and may be updated regularly as some of this information (e.g., error/noise levels, coherence times) may change frequently on a given quantum computing device 104.

Network 103 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, and various combinations thereof. Other networks, whose descriptions are omitted here for brevity, may also be used in conjunction with system 100 of FIG. 1 without departing from the scope of the present disclosure.

Referring now to FIG. 2, FIG. 2 illustrates the internal structure of quantum computing device 104 in accordance with an embodiment of the present disclosure.

In one embodiment, a hardware structure 201 of quantum computing device 104 includes a control and measurement plane 202, a control processor plane 203, a quantum controller 204, and a quantum processor 205.

Control and measurement plane 202 converts the digital signals of quantum controller 204, which indicates what quantum operations are to be performed, to the analog control signals needed to perform the operations on the qubits. In one embodiment, control and measurement plane 202 converts the analog output of the measurements of qubits to classical binary data that quantum controller 204 can handle.

Control processor plane 203 identifies and triggers the sequence of quantum gate operations and measurements (which are subsequently carried out by control and measurement plane 202). These sequences execute the program, provided by quantum processor 205, for implementing a quantum algorithm.

In one embodiment, control processor plane 203 runs the quantum error correction algorithm (if quantum computing device 104 is error corrected).

In one embodiment, quantum processor 205 uses qubits to perform computational tasks. In the particular realms where quantum mechanics operate, particles of matter can exist in multiple states, such as an “on” state, an “off” state and both “on” and “off” states simultaneously. Quantum processor 205 harnesses these quantum states of matter to output signals that are usable in data computing.

In one embodiment, quantum processor 205 performs algorithms which conventional processors are incapable of performing efficiently.

In one embodiment, quantum processor 205 executes one or more quantum circuits 110. Quantum circuits 110 may collectively or individually be referred to as quantum circuits 110 or quantum circuit 110, respectively. A “quantum circuit 110,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX}, which corresponds to a rotation of the qubit state around the X-axis by the given angle theta θ on the Bloch sphere), RY (performs e^{iθY}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 110 are written such that the horizontal axis is time, starting at the left-hand side and ending at the right-hand side.

Furthermore, in one embodiment, quantum circuit 110 corresponds to a command structure provided to control processor plane 203 on how to operate control and measurement plane 202 to run the algorithm on quantum processor 205.

Furthermore, quantum computing device 104 includes memory 206, which may correspond to quantum memory. In one embodiment, memory 206 is a set of quantum bits that store quantum states for later retrieval. The state stored in quantum memory 206 can retain quantum superposition.

In one embodiment, memory 206 stores an application 207 that may be configured to implement one or more of the methods described herein in accordance with one or more embodiments. In one embodiment, application 207 implements a program for executing the instructions of the optimized quantum jobs and/or models. Examples of memory 206 include light quantum memory, solid quantum memory, gradient echo memory, electromagnetically induced transparency, etc.

Referring now to FIG. 3, in conjunction with FIG. 1, FIG. 3 illustrates an embodiment of the present disclosure of the hardware configuration of orchestration server 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (stored in block 301) involved in performing the inventive methods, such as sharing qubits across simultaneous quantum circuit execution. In addition to block 301, computing environment 300 includes, for example, orchestration server 102, network 103, such as a wide area network (WAN), end user device (EUD) 302, remote server 303, public cloud 304, and private cloud 305. In this embodiment, orchestration server 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Orchestration server 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically orchestration server 102, to keep the presentation as simple as possible. Orchestration server 102 may be located in a cloud, even though it is not shown in a cloud in FIG. 3. On the other hand, orchestration server 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto orchestration server 102 to cause a series of operational steps to be performed by processor set 306 of orchestration server 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of orchestration server 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In orchestration server 102, the volatile memory 310 is located in a single package and is internal to orchestration server 102, but, alternatively or additionally, the volatile memory may be distributed over multiple packages and/or located externally with respect to orchestration server 102.

Persistent Storage 311 is any form of non-volatile storage for computers that is now known or to be developed in the future. The non-volatility of this storage means that the stored data is maintained regardless of whether power is being supplied to orchestration server 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of orchestration server 102. Data communication connections between the peripheral devices and the other components of orchestration server 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where orchestration server 102 is required to have a large amount of storage (for example, where orchestration server 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows orchestration server 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to orchestration server 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates orchestration server 102), and may take any of the forms discussed above in connection with orchestration server 102. EUD 302 typically receives helpful and useful data from the operations of orchestration server 102. For example, in a hypothetical case where orchestration server 102 is designed to provide a recommendation to an end user, this recommendation would typically be communicated from network module 317 of orchestration server 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to orchestration server 102. Remote server 303 may be controlled and used by the same entity that operates orchestration server 102. Remote server 303 represents the machine(s) that collect and store helpful and useful data for use by other computers, such as orchestration server 102. For example, in a hypothetical case where orchestration server 102 is designed and programmed to provide a recommendation based on historical data, then this historical data may be provided to orchestration server 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components (e.g., quantum circuit comparison module 106, qubit minimization quantum circuit combination module 107, etc.) discussed above in connection with FIG. 1 to share qubits across simultaneous quantum job and/or trained model execution. In one embodiment, such components may be implemented in hardware. The functions discussed above performed by such components are not generic computer functions. As a result, orchestration server 102 is a particular machine that is the result of implementing specific, non-generic computer functions.

In one embodiment, the functionality of such software components of orchestration server 102, including the functionality for sharing qubits across simultaneous quantum job and/or trained model execution, may be embodied in an application specific integrated circuit.

As stated above, due to their superior modeling capacity, quantum computers will be increasingly used to simulate complex, composite objects, systems, and processes of the real world. Given the limited availability of quantum hardware, executing a large number of quantum jobs and/or trained models will require compartmentalization of tasks and simultaneous execution of quantum jobs and/or trained models on one or more processors. A quantum job refers to a unit of work or a unit of execution (that performs said work) involving a quantum task. A trained model refers to a quantum machine learning model that is an expression of an algorithm that has been trained to represent the actions of an object, environment, or person, where the model is represented as one or more quantum circuits. These simultaneously running quantum jobs and/or trained models may be completely independent in some scenarios, and in other scenarios may involve computations that have interactions between the quantum jobs and/or trained models. Examples of computations that have interactions between quantum jobs and/or trained models can relate to the metaverse, digital twins, and/or an augmented reality (AR) cloud. Digital twins are virtual representations of a real-world object or process. Several technologies, including machine learning (ML)/artificial intelligence (AI), Internet of Things, and quantum computing are connected with and help accelerate progress in the field of digital twins. One area of particular interest is the interactions between digital twins. As metaverses (a metaverse refers to any digital or virtual reality platform that combines any combination of aspects from online gaming, social media, virtual reality, augmented reality, cryptocurrencies, or non-fungible tokens for users to interact with one another) become a reality, it is foreseen that digital twins will increasingly need to communicate with one another. For example, the digital twins of machinery in a factory may be impacted by digital twins of other machinery or by the digital twins representing the environment and factory workers. In another example, in a metaverse where many users are virtually attending a sporting event, the quantum jobs and/or trained models representing other fans at the game may react similarly in some aspects and differently in others depending on what is happening in the game. In either situation, it is possible that redundant calculations are occurring between the quantum jobs and/or trained models that are running simultaneously on the same quantum processor (e.g., Eagle, Osprey, Condor) or linked quantum processors on the same quantum computer (e.g., Flamingo, Heron, Kookaburra). By the occurrence of such redundant calculations, qubits are being wasted which limits the number of quantum jobs and/or trained models that can be executed simultaneously.

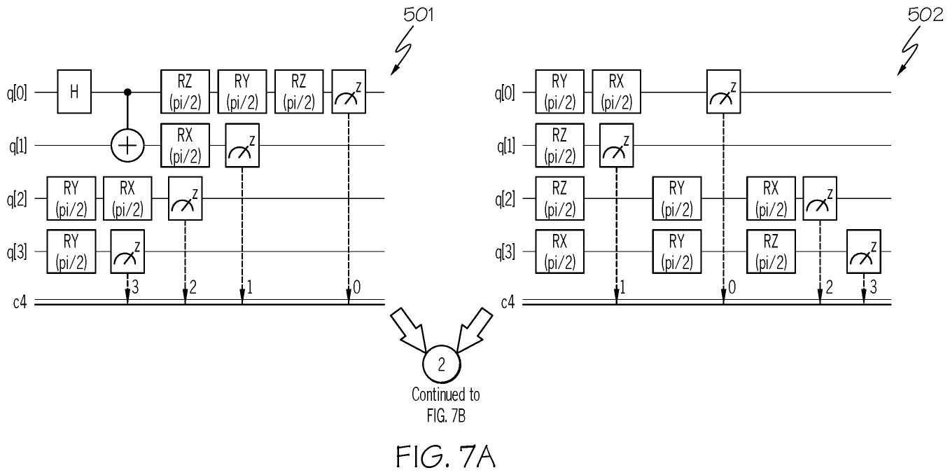

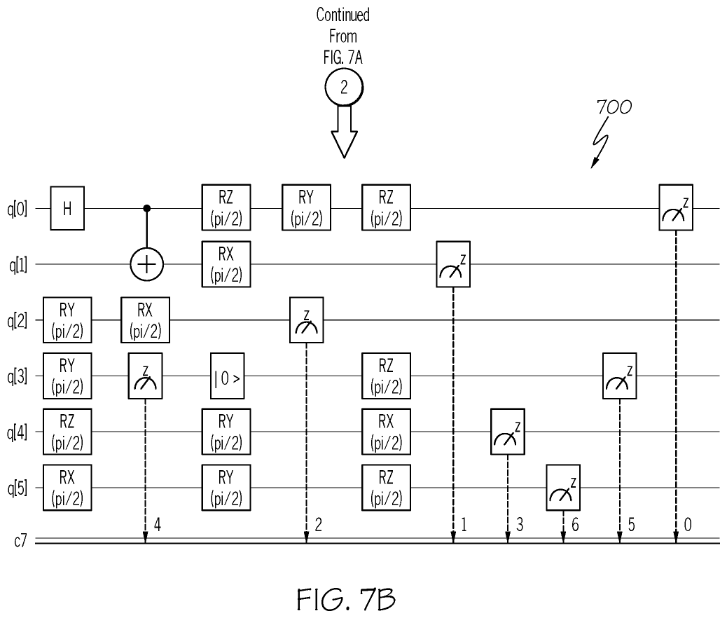

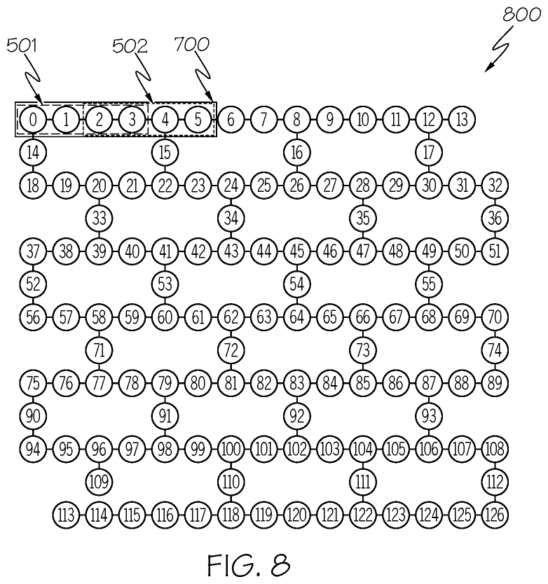

The embodiments of the present disclosure provide the means for reducing the occurrence of redundant calculations by sharing qubits across simultaneous quantum job and/or trained model execution as discussed below in connection with FIGS. 4, 5A-5B, 6A-6B, 7A-7B and 8. FIG. 4 is a flowchart of a method for comparing quantum jobs and/or trained models to determine if there are matching qubits or qubit groups that have the same starting state and perform the same function. FIGS. 5A-5B illustrate a matching qubit group. FIGS. 6A-6B are a flowchart of a method for generating a minimized quantum job and/or trained model based on various factors. FIGS. 7A-7B illustrates combining multiple quantum jobs and/or trained models into a quantum job and/or trained model that utilizes fewer qubits. FIG. 8 illustrates positioning a single compressed quantum job and/or model on a coupling map.

As stated above, FIG. 4 is a flowchart of a method 400 for comparing quantum jobs and/or trained models to determine if there are matching qubits or qubit groups that have the same starting state and perform the same function in accordance with an embodiment of the present disclosure.

Referring to FIG. 4, in conjunction with FIGS. 1-3, in step 401, quantum circuit comparison module 106 imports quantum jobs 109 and/or trained models 105. In one embodiment, such quantum jobs 109 and/or trained models 105 are imported from connected external devices 101 that are to be executed simultaneously.

In one embodiment, such quantum jobs 109 and/or trained models 105 are previously trained machine learning models. In one embodiment, such quantum jobs 109 and/or trained models 105 represent entities that interact with each other. In one embodiment, such quantum jobs 105 and/or trained models 105 represent digital twins or entities within a metaverse.

In step 402, quantum circuit comparison module 106 identifies qubit groups within quantum jobs 109 and/or trained models 105. A “qubit group,” as used herein, refers to a group of two or more qubits that has a multi-qubit gate acting on the qubits at any point in quantum job 109 and/or trained model 105 or a single qubit if the qubit is never entangled with another qubit through the entire quantum job 105 and/or trained model 105.

In one embodiment, quantum circuit comparison module 106 identifies qubits or qubit groups after transpilation, if any.

In step 403 quantum circuit comparison module 106 selects the first quantum jobs 109 and/or trained model 105 from the imported quantum jobs 109 and/or trained models 105 of step 401 amongst all the quantum jobs 109 and/or models 105 that are to be executed simultaneously.

In step 404, quantum circuit comparison module 106 selects the first qubit group of the selected quantum job 109 and/or trained model 105.

In step 405, quantum circuit comparison module 106 compares the selected qubit group to the qubit group from the other quantum jobs 109 and/or trained models 105 to identify qubit groups within the quantum jobs 109 and/or trained models 105 that match with respect to a starting state and a gate structure. That is, quantum circuit comparison module 106 compares the selected qubit group to the qubit groups from the other quantum jobs 109 and/or trained models 105 to identify matching qubit groups that have the same starting state and quantum gate structure. The starting state, as used herein, refers to the initial state. The gate structure, as used herein, refers to the quantum logic gates.

An example of quantum circuit comparison module 106 identifying a matching qubit group with respect to a starting state and a gate structure based on comparing the selected qubit group to the qubit groups from the other quantum jobs 109 and/or trained models 105 is provided in FIGS. 5A-5B.

FIGS. 5A-5B illustrate a matching qubit group in accordance with an embodiment of the present disclosure.

Referring to FIGS. 5A-5B, FIGS. 5A-5B illustrate two quantum circuits, quantum circuit 501 and quantum circuit 502. As shown in FIG. 5A, quantum circuit 501 includes qubit groups (which may refer to a single qubit if the qubit is never entangled with another qubit through the entire quantum job 105 and/or trained model 105), q(0), q(1), q(2), and q(3). As further shown in FIG. 5B, quantum circuit 502 includes qubit groups, q(0), q(1), q(2), and q(3).

Furthermore, as illustrated in FIGS. 5A-5B, qubit group q(2) of quantum circuit 501 matches qubit group q(0) of quantum circuit 502 by having a matching starting state (e.g., probably of |1) state being 50%, which is not shown in FIGS. 5A-5B) and gate structure (e.g., RY, RX).

Returning to FIG. 4, in conjunction with FIGS. 1-3 and 5A-5B, quantum circuit comparison module 106 utilizes various software tools for comparing the selected qubit group to the qubit groups from the other quantum jobs 109 and/or trained models 105 to identify matching qubit groups that have the same starting state and quantum gate structure, including, but not limited to, Classiq®, Qiskit®, Quantify, Cirq®, Perceval®, QCircuits, Qulacs®, staq, etc.

In step 406, quantum circuit comparison module 106 determines whether qubit groups match with respect to a starting state and a gate structure.

If there is a match, as discussed above, then, in step 407, quantum circuit comparison module 106 records the matching qubit groups for potential overlapping on the coupling map. It is noted that such a matched pair of qubit groups may potentially be overlapping on the coupling map. The final determination as to whether such a matched pair of qubit groups is indeed overlapping on the coupling map occurs in method 600, where other considerations are addressed, as discussed further below in connection with FIGS. 6A-6B.

In one embodiment, such a record is stored in a defined memory location on orchestration server 102, temporary memory within orchestration server 102, quantum system information database 108, or storage elsewhere within network 103.

If the qubit groups do not match with respect to a starting state and a gate structure, or upon recording the matching qubit groups for potential overlapping on the coupling map, then, in step 408, quantum circuit comparison module 106 determines whether there are more qubit groups to analyze in the currently selected quantum job 109 and/or trained model 105.

If there are more qubit groups to analyze in the currently selected quantum job 109 and/or trained model 105, then the next qubit group is selected by quantum circuit comparison module 106 in step 404.

If, however, there are no more qubit groups to analyze in the currently selected quantum job 109 and/or trained model 105, then, in step 409, quantum circuit comparison module 106 determines whether there are any more quantum jobs 109 and/or trained models 105 to compare.

If there are other quantum jobs 109 and/or trained models 105 to compare, then quantum circuit comparison module 106 selects the next quantum job 109 and/or trained model 105 in step 403.

If, however, there are no other quantum jobs 109 and/or trained models 105 to compare, then, in step 410, quantum circuit comparison module 106 outputs the record of the matching qubit groups based on the recording performed in step 407 over several iterations. That is, upon completion of method 400, such a record contains all the matching qubit groups that have the same starting state and perform the same function across all quantum jobs 109 and/or models 105 that are to be executed simultaneously.

Such a record may be used for generating a minimized quantum job 109 and/or trained model 105 as discussed below in connection with FIGS. 6A-6B.

FIGS. 6A-6B are a flowchart of a method 600 for generating a minimized quantum job and/or trained model based on various factors in accordance with an embodiment of the present disclosure.

As discussed below, method 600 generates a minimized quantum circuit based on multiple factors, including the output of quantum circuit comparison module 106 (output of method 400), whether a qubit group can be reset and reused for another computation in another quantum job 109 and/or trained model 105 in which the circuit depth of both computations plus the qubit reset time is less than the circuit depth of the longest qubit group amongst all quantum jobs 109 and/or models 105 and model placement to share one or more qubit groups on the coupling map.

Referring to FIG. 6A, in conjunction with FIGS. 1-4 and 5A-5B, in step 601, qubit minimization quantum circuit combination module 107 imports the quantum jobs 109 and/or trained models 105, if not previously imported, such as being previously imported by quantum circuit comparison module 106 in step 401 of method 400.

In one embodiment, such quantum jobs 109 and/or trained models 105 are previously trained machine learning models. In one embodiment, such quantum jobs 109 and/or trained models 105 represent entities that interact with each other. In one embodiment, such quantum jobs 109 and/or trained models 105 represent digital twins or entities within a metaverse.

In step 602, qubit minimization quantum circuit combination module 107 imports the record of matching qubit groups, which was outputted by quantum circuit comparison module 106 in method 400.

In step 603, qubit minimization quantum circuit combination module 107 selects the first quantum job 109 and/or trained model 105 of the imported quantum jobs 109 and/or trained models 105 of step 601 amongst all the quantum jobs 109 and/or models 105 that are to be executed simultaneously.

In step 604, qubit minimization quantum circuit combination module 107 records the depth of each qubit group of the matching qubit groups obtained in step 602 within a quantum job 109 and/or trained model 105 of the currently selected quantum job 109 and/or trained model 105. The depth of a qubit group, as used herein, refers to the path from the input to the output or measurement gate corresponding to the execution time.

In one embodiment, such a record is stored in a defined memory location on orchestration server 102, temporary memory within orchestration server 102, quantum system information database 108, or storage elsewhere within network 103.

Qubit minimization quantum circuit combination module 107 uses various software tools for recording the depth of each qubit group within a quantum job 109 and/or trained model 105 of the currently selected quantum job 109 and/or trained model 105, including, but not limited to, Classiq®, Qiskit®, Quantify, Cirq®, Perceval®, QCircuits, Qulacs®, staq, etc.

In step 605, qubit minimization quantum circuit combination module 107 records whether each qubit group of the matching qubit groups within the currently selected quantum job 109 and/or trained model 105 can be considered for reset and reuse after computation. That is, qubit minimization quantum circuit combination module 107 records whether each qubit group of the matching qubit groups within the currently selected quantum job 109 and/or trained model 105 can be used for a subsequent computation after being reset.

In one embodiment, qubit minimization quantum circuit combination module 107 determines which qubit group within the currently selected quantum job 109 and/or trained model 105 can be considered for reset and reuse based on comparing the depth of the qubit group (execution time) with a user-designated threshold amount of time to ensure there is enough time for reset and reuse. In one embodiment, if the depth of the qubit group is less than the user-designated threshold amount of time, then the qubit group is considered for reset and reuse. Otherwise, the qubit group cannot be considered for reset and reuse.

In one embodiment, such a record is stored in a defined memory location on orchestration server 102, temporary memory within orchestration server 102, quantum system information database 108, or storage elsewhere within network 103.

In one embodiment, all qubit groups can be considered for reset and reuse after computation.

In step 606, qubit minimization quantum circuit combination module 107 determines whether there are any additional quantum jobs 109 and/or trained models 105 to analyze.

If there are additional quantum jobs 109 and/or trained models 105 to analyze, then qubit minimization quantum circuit combination module 107 selects the next quantum job 109 and/or trained model 105 of the imported quantum jobs 109 and/or trained models 105 of step 601 in step 603.

If, however, there are no more quantum jobs 109 and/or trained models 105 to analyze, then, in step 607, qubit minimization quantum circuit combination module 107 identifies the qubit groups from separate quantum jobs 109 and/or models 105 that can be considered for dynamic quantum job and/or model reset and reuse for another computation during a same simultaneous quantum job and/or model execution in which a depth of the qubit groups from separate quantum jobs 109 and/or models 105 plus a qubit reset time is less than a depth of the longest qubit group of all the quantum jobs 109 and/or trained models 105.

In one embodiment, qubit minimization quantum circuit combination module 107 identifies the depth of the longest qubit group of all the quantum jobs 109 and/or trained models 105 from the record built at step 604 after the iterations of steps 603-606 have been completed, which contains the depth of all the qubit groups. Based on extracting the depth of each of the qubit groups of the quantum jobs 109 and/or trained models 105 from the record built at step 604, qubit minimization quantum circuit combination module 107 identifies the depth of the longest qubit group. In one embodiment, qubit minimization quantum circuit combination module 107 utilizing various software tools for identifying the depth of the longest qubit group in such a manner, including, but not limited to, Classiq®, Qiskit®, Quantify, Cirq®, Perceval®, QCircuits, Qulacs®, staq, etc.

In one embodiment, qubit minimization quantum circuit combination module 107 identifies those qubit groups that can be considered for reset and reuse from the record built in step 605 after the iterations of steps 603-606 have been completed. If a qubit group is listed in such a record, then such a qubit group is considered for reset and reuse. In one embodiment, a qubit group can be reset using a reset gate, whose execution time is known. Such an execution time is referred to herein as the “qubit reset time.”

An example of qubit groups that can be considered for reset and reuse is illustrated in FIGS. 5A-5B. As shown in FIGS. 5A-5B, qubit group q(3) of quantum circuit 501 and qubit group q(1) of quantum circuit 502 can be considered for reset and reuse. As discussed further below, the combination of such qubit groups (shown as q(3) in quantum circuit 700 of FIGS. 7A-7B) makes use of the same qubit between the two quantum circuits and is less than the total circuit depth of the longest qubit group between circuits 501, 502, which is qubit group q(0) of quantum circuit 501.

After identifying qubit groups that can be considered for dynamic quantum job and/or model reset and reuse for another computation during a same simultaneous quantum job and/or model execution, the depth of the qubit groups from separate quantum jobs 109 and/or models 105 plus the qubit reset time is compared with the depth of the longest qubit group of all the quantum jobs 109 and/or trained models 105. If the depth of the qubit groups from separate quantum jobs 109 and/or models 105 plus the qubit reset time is less than the depth of the longest qubit group of all the quantum jobs 109 and/or trained models 105, then such qubit groups are considered for potential quantum job and/or model minimizations. Otherwise, such qubit groups are not considered for potential quantum job and/or model minimizations.

In step 608, quantum minimization quantum circuit combination module 107 creates a record of potential quantum job and/or model minimizations based on the identification of matching qubit groups and the identification of qubit groups that are considered for dynamic quantum job and/or model reset and reuse in which a depth of the qubit groups from separate quantum jobs 109 and/or models 105 plus a qubit reset time is less than a depth of the longest qubit group of all the quantum jobs 109 and/or trained models 105. “Circuit minimization,” as used herein, refers to combining quantum jobs 109 and/or trained models 105 in a manner that results in utilizing fewer qubits.

As discussed above, after identifying qubit groups that can be considered for dynamic quantum job and/or model reset and reuse for another computation during a same simultaneous quantum job and/or model execution, the depth of the qubit groups from separate quantum jobs 109 and/or models 105 plus the qubit reset time is compared with the depth of the longest qubit group of all the quantum jobs 109 and/or trained models 105. If the depth of the qubit groups from separate quantum jobs 109 and/or models 105 plus the qubit reset time is less than the depth of the longest qubit group of all the quantum jobs 109 and/or trained models 105, then such qubit groups are considered for potential quantum job and/or model minimizations.

Hence, potential quantum job and/or model minimizations include matching qubit groups, which were imported in step 602, and qubits groups that can be reset and reused in which the depth of the qubit groups from separate quantum jobs 109 and/or models 105 plus the qubit reset time is less than the depth of the longest qubit group among all the quantum jobs 109 and/or trained models 105. Such potential quantum job and/or model minimizations may then be recorded, such as in the record of potential quantum job and/or model minimizations.

An example of such a quantum job and/or model minimization (combining quantum jobs 109 and/or models 105 in a manner that results in utilizing fewer qubits) is illustrated in FIGS. 7A-7B.

FIGS. 7A-7B illustrate combining multiple quantum jobs 109 and/or trained models 105 into a quantum job 109 and/or trained model 105 that utilizes fewer qubits in accordance with an embodiment of the present disclosure.

As shown in FIGS. 7A-7B, quantum circuits 501 and 502 can be combined into quantum circuit 700 which uses 6 qubits instead of 8 qubits which would be necessary if quantum circuit 501 and quantum circuit 502 ran simultaneously at different positions on the coupling map.

Furthermore, as shown in FIGS. 7A-7B, qubit groups q(0) and q(1) of quantum circuit 501 remains unchanged as qubit groups q(0) and q(1) of quantum circuit 700.

Qubit group q(2) of quantum circuit 501 and qubit group q(0) of quantum circuit 502 are identical and only execute once as qubit group q(2) of quantum circuit 700.

Qubit group q(2) of quantum circuit 502 remains unchanged as qubit group q(4) of quantum circuit 700. Qubit group q(3) of quantum circuit 502 remains unchanged as qubit group q(5) of quantum circuit 700.

Furthermore, qubit group q(3) of quantum circuit 501 is replicated at the beginning of qubit group q(3) of quantum circuit 700. Qubit group q(3) of quantum circuit 700 is also reset and reused to execute qubit group q(1) of quantum circuit 502.

Returning to FIG. 6A, in conjunction with FIGS. 1-4, 5A-5B and 7A-7B, in one embodiment, the record of potential quantum job and/or model minimizations is stored in a defined memory location on orchestration server 102, temporary memory within orchestration server 102, quantum system information database 108, or storage elsewhere within network 103.

It is noted that such quantum job and/or model minimizations are “potential” because a determination needs to be performed to determine whether such quantum jobs 109 and/or trained models 105 can be placed on the coupling map for quantum computing device 104 using shared qubits. Such a determination is based on information extracted from quantum system information database 108.

In step 609, quantum minimization quantum circuit combination module 107 determines whether the quantum jobs 109 and/or trained models 105 can be positioned on the coupling map based on the current record of potential quantum job and/or model minimizations. As discussed above, the coupling map refers to a connectively pattern and physical layout of the qubits in the quantum processor that determines which qubits can interact directly with each other, such as via a two-qubit gate.

If not all the quantum jobs 109 and/or trained models 105 can be posited on the coupling map, then, in step 610, quantum minimization quantum circuit combination module 107 removes a potential quantum job and/or model minimization (e.g., matching qubit group q(0) of quantum circuit A with qubit group q(1) of quantum circuit B) from the record of step 608. Upon removing a potential quantum job and/or model minimization from the record, quantum minimization quantum circuit combination module 107 again determines whether the quantum jobs 109 and/or trained models 105 can be positioned on the coupling map based on the current record of potential quantum job and/or model minimizations in step 609.

In one embodiment, such an iteration of steps 609, 610 involves removing a potential quantum job and/or model minimization and continues removing a further potential quantum job and/or model minimization until an option allows for placement on the coupling map.

In one embodiment, if the removal of a single finding from the potential quantum job and/or model minimizations record does not result in the quantum jobs 109 and/or trained models 105 being able to be positioned on the coupling map, then quantum minimization quantum circuit combination module 107 removes combinations of two potential quantum job and/or model minimizations from the record and so on until an option is found that allows all the quantum jobs 109 and/or trained models 105 to be placed on the coupling map.

In one embodiment, sharing of a qubit may not be performed if error/noise associated with said qubit is above a threshold level, which may be user-designated.

In one embodiment, if multiple locations can be chosen on the coupling map, the selected location is the one with the collection of qubits that has the lowest error/noise and/or best coherence times.

In one embodiment, in the worst-case scenario, all potential quantum job and/or model minimizations will be exhausted and none can be used which will place all quantum jobs 109 and/or trained models 105 separately on the coupling map with no qubit sharing. In such a scenario, in one embodiment, a different quantum computing device 104 with a different or larger coupling map to execute the quantum jobs 109 and/or training models 105 simultaneously needs to be utilized.

Referring to FIG. 6B, in conjunction with FIGS. 1-4, 5A-5B and 7A-7B, if the quantum jobs 109 and/or trained models 105 can be positioned on the coupling map, then, in step 611, quantum minimization quantum circuit combination module 107 generates one or more single compressed quantum jobs 109 and/or models 105, where each single compressed quantum job 109 and/or model 105 is generated using two or more quantum jobs 109 and/or trained models 105 that can share qubits.

In step 612, quantum minimization quantum circuit combination module 107 positions the single compressed quantum job(s) 109 and/or model(s) 105 on the coupling map as shown in FIG. 8 and the other quantum jobs 109 and/or trained models 105, if any, on the coupling map that cannot share qubits and have no quantum job and/or model changes.

For example, in the embodiment in which specific quantum jobs 109 and/or trained models 105 will consistently run simultaneously over time (e.g., combining quantum jobs and/or models of a digital twin for parts that will function together regularly), the larger model that is created at step 611 that encompasses multiple quantum jobs 109 and/or trained models 105 could be used as a starting point and further trained as a whole for optimization.

In one embodiment, the number of shots (corresponds to one complete execution of a quantum circuit) is set to the maximum for all quantum jobs 109 and/or models 105 that are combined on the same quantum circuit.

Referring to FIG. 8, FIG. 8 illustrates positioning a single compressed quantum job and/or model on a coupling map in accordance with an embodiment of the present disclosure.

As shown in FIG. 8, in conjunction with FIGS. 5A-5B and 7A-7B, quantum circuit 501 and quantum circuit 502 are placed on coupling map 800 to form one quantum circuit 700 that uses a total of 6 qubits as opposed to 8 qubits which would be necessary if quantum circuit 501 and quantum circuit 502 ran simultaneously at different positions on the coupling map.

As a result of the foregoing, the principles of the present disclosure reduce the occurrence of redundant calculations by sharing qubits across simultaneous quantum job and/or trained model execution.

Furthermore, the principles of the present disclosure improve the technology or technical field involving quantum computing. As discussed above, due to their superior modeling capacity, quantum computers will be increasingly used to simulate complex, composite objects, systems, and processes of the real world. Given the limited availability of quantum hardware, executing a large number of quantum jobs and/or trained models will require compartmentalization of tasks and simultaneous execution of quantum jobs and/or trained models on one or more processors. A quantum job refers to a unit of work or a unit of execution (that performs said work) involving a quantum task. A trained model refers to a quantum machine learning model that is an expression of an algorithm that has been trained to represent the actions of an object, environment, or person, where the model is represented as one or more quantum circuits. These simultaneously running quantum jobs and/or trained models may be completely independent in some scenarios, and in other scenarios may involve computations that have interactions between the quantum jobs and/or trained models. Examples of computations that have interactions between quantum jobs and/or trained models can relate to the metaverse, digital twins, and/or an augmented reality (AR) cloud. Digital twins are virtual representations of a real-world object or process. Several technologies, including machine learning (ML)/artificial intelligence (AI), Internet of Things, and quantum computing are connected with and help accelerate progress in the field of digital twins. One area of particular interest is the interactions between digital twins. As metaverses (a metaverse refers to any digital or virtual reality platform that combines any combination of aspects from online gaming, social media, virtual reality, augmented reality, cryptocurrencies, or non-fungible tokens for users to interact with one another) become a reality, it is foreseen that digital twins will increasingly need to communicate with one another. For example, the digital twins of machinery in a factory may be impacted by digital twins of other machinery or by the digital twins representing the environment and factory workers. In another example, in a metaverse where many users are virtually attending a sporting event, the quantum jobs and/or trained models representing other fans at the game may react similarly in some aspects and differently in others depending on what is happening in the game. In either situation, it is possible that redundant calculations are occurring between the quantum jobs and/or trained models that are running simultaneously on the same quantum processor (e.g., Eagle, Osprey, Condor) or linked quantum processors on the same quantum computer (e.g., Flamingo, Heron, Kookaburra). By the occurrence of such redundant calculations, qubits are being wasted which limits the number of quantum jobs and/or trained models that can be executed simultaneously.

Embodiments of the present disclosure improve such technology by identifying qubit groups within quantum jobs and/or trained models that match with respect to a starting state and a gate structure. A “quantum job,” as used herein, refers to a unit of work or a unit of execution (that performs said work) involving a quantum task. A “trained model” (or simply referred to herein as “model”), as used herein, refers to a quantum machine learning model that is an expression of an algorithm that has been trained to represent the actions of an object, environment, or person, where the model is represented as one or more quantum circuits. A qubit group corresponds to a single qubit if the qubit is never entangled with another qubit through the entire quantum job and/or trained model or a group of two or more qubits that has a multi-qubit gate acting on the qubits at any point in the quantum job and/or trained model. The starting state, as used herein, refers to the initial state. The gate structure, as used herein, refers to the quantum logic gates. Furthermore, qubit groups from separate quantum jobs and/or models that are considered for dynamic quantum job and/or model reset and reuse for another computation during a same simultaneous quantum job and/or model execution in which a depth of the qubit groups from separate quantum jobs and/or models plus a qubit reset time is less than a depth of the longest qubit group of all the quantum jobs and/or trained models are identified. Upon identifying such qubit groups, a record of potential quantum job and/or model minimizations based on such identified qubit groups is created. A determination is then made as to whether all the quantum jobs and/or trained models can be placed on a coupling map (a connectively pattern and physical layout of the qubits in the quantum processor that determines which qubits can interact directly with each other, such as via a two-qubit gate) with the current record of potential quantum job and/or model minimizations. If not, then a potential quantum job and/or model minimization is removed one at a time from the record until all the quantum jobs and/or trained models can be positioned on the coupling map. Once the quantum jobs and/or trained models can be positioned on the coupling map, one or more single compressed quantum jobs and/or trained models are generated that each use two or more quantum jobs and/or trained models that can share qubits based on the current record of potential quantum job and/or model minimizations. The single compressed quantum job(s) and/or trained model(s) are then positioned on the coupling map along with the other quantum jobs and/or trained models that cannot share qubits and have no quantum job and/or model changes. In this manner, the occurrences of redundant calculations are reduced by sharing qubits across simultaneous quantum job and/or trained model execution. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for qubit sharing across simultaneous quantum job and/or model execution, the method comprising:
identifying qubit groups within a plurality of quantum jobs and/or models that match with respect to a starting state and a gate structure;
identifying qubit groups from separate quantum jobs and/or models of said plurality of quantum jobs and/or models that are considered for dynamic quantum job and/or model reset and reuse for another computation during a same simultaneous quantum job and/or model execution;
creating a record of potential quantum job and/or model minimizations based on said identification of said matching qubit groups and said identification of said qubit groups that are considered for dynamic quantum job and/or model reset and reuse;
generating a single compressed quantum job and/or model using two or more quantum jobs and/or models of said plurality of quantum jobs and/or models that can share qubits based on a current record of potential quantum job and/or model minimizations; and
positioning said single compressed quantum job and/or model on a coupling map.

2. The method as recited in claim 1 further comprising:
removing a potential quantum job and/or model minimization from said created record of potential quantum job and/or model minimizations one at a time until said plurality of quantum jobs and/or models can be positioned on said coupling map thereby forming said current record of potential quantum job and/or model minimizations.

3. The method as recited in claim 1, wherein said plurality of quantum jobs and/or models are previously trained machine learning models.

4. The method as recited in claim 1, wherein said plurality of quantum jobs and/or models represent entities that interact with each other.

5. The method as recited in claim 1, wherein said plurality of quantum jobs and/or models represent digital twins or entities within a metaverse.

6. The method as recited in claim 1 further comprising:
identifying said qubit groups from said separate quantum jobs and/or models of said plurality of quantum jobs and/or models that are considered for dynamic quantum job and/or model reset and reuse for another computation during said same simultaneous quantum job and/or model execution in which a depth of said qubit groups from said separate quantum jobs and/or models of said plurality of quantum jobs and/or models plus a qubit reset time is less than a depth of a longest qubit group of said plurality of quantum jobs and/or models.

7. The method as recited in claim 1, wherein said qubit groups that are identified within said plurality of quantum jobs and/or models correspond to a single qubit or a group of two or more qubits that have a multi-qubit gate acting on them at any point in a quantum job and/or model.

8. A computer program product for qubit sharing across simultaneous quantum job and/or model execution, the computer program product comprising one or more computer readable storage mediums having program code embodied therewith, the program code comprising programming instructions for:
identifying qubit groups within a plurality of quantum jobs and/or models that match with respect to a starting state and a gate structure;
identifying qubit groups from separate quantum jobs and/or models of said plurality of quantum jobs and/or models that are considered for dynamic quantum job and/or model reset and reuse for another computation during a same simultaneous quantum job and/or model execution;
creating a record of potential quantum job and/or model minimizations based on said identification of said matching qubit groups and said identification of said qubit groups that are considered for dynamic quantum job and/or model reset and reuse;
generating a single compressed quantum job and/or model using two or more quantum jobs and/or models of said plurality of quantum jobs and/or models that can share qubits based on a current record of potential quantum job and/or model minimizations; and
positioning said single compressed quantum job and/or model on a coupling map.

9. The computer program product as recited in claim 8, wherein the program code further comprises the programming instructions for:
removing a potential quantum job and/or model minimization from said created record of potential quantum job and/or model minimizations one at a time until said plurality of quantum jobs and/or models can be positioned on said coupling map thereby forming said current record of potential quantum job and/or model minimizations.

10. The computer program product as recited in claim 8, wherein said plurality of quantum jobs and/or models are previously trained machine learning models.

11. The computer program product as recited in claim 8, wherein said plurality of quantum jobs and/or models represent entities that interact with each other.

12. The computer program product as recited in claim 8, wherein said plurality of quantum jobs and/or models represent digital twins or entities within a metaverse.

13. The computer program product as recited in claim 8, wherein the program code further comprises the programming instructions for:
identifying said qubit groups from said separate quantum jobs and/or models of said plurality of quantum jobs and/or models that are considered for dynamic quantum job and/or model reset and reuse for another computation during said same simultaneous quantum job and/or model execution in which a depth of said qubit groups from said separate quantum jobs and/or models of said plurality of quantum jobs and/or models plus a qubit reset time is less than a depth of a longest qubit group of said plurality of quantum jobs and/or models.

14. The computer program product as recited in claim 8, wherein said qubit groups that are identified within said plurality of quantum jobs and/or models correspond to a single qubit or a group of two or more qubits that have a multi-qubit gate acting on them at any point in a quantum job and/or model.

15. A system, comprising:
a memory for storing a computer program for qubit sharing across simultaneous quantum job and/or model execution; and
a processor connected to said memory, wherein said processor is configured to execute program instructions of the computer program comprising:
identifying qubit groups within a plurality of quantum jobs and/or models that match with respect to a starting state and a gate structure;
identifying qubit groups from separate quantum jobs and/or models of said plurality of quantum jobs and/or models that are considered for dynamic quantum job and/or model reset and reuse for another computation during a same simultaneous quantum job and/or model execution;
creating a record of potential quantum job and/or model minimizations based on said identification of said matching qubit groups and said identification of said qubit groups that are considered for dynamic quantum job and/or model reset and reuse;
generating a single compressed quantum job and/or model using two or more quantum jobs and/or models of said plurality of quantum jobs and/or models that can share qubits based on a current record of potential quantum job and/or model minimizations; and
positioning said single compressed quantum job and/or model on a coupling map.

16. The system as recited in claim 15, wherein the program instructions of the computer program further comprise:
removing a potential quantum job and/or model minimization from said created record of potential quantum job and/or model minimizations one at a time until said plurality of quantum jobs and/or models can be positioned on said coupling map thereby forming said current record of potential quantum job and/or model minimizations.

17. The system as recited in claim 15, wherein said plurality of quantum jobs and/or models are previously trained machine learning models.

18. The system as recited in claim 15, wherein said plurality of quantum jobs and/or models represent entities that interact with each other.

19. The system as recited in claim 15, wherein said plurality of quantum jobs and/or models represent digital twins or entities within a metaverse.

20. The system as recited in claim 15, wherein the program instructions of the computer program further comprise:
identifying said qubit groups from said separate quantum jobs and/or models of said plurality of quantum jobs and/or models that are considered for dynamic quantum job and/or model reset and reuse for another computation during said same simultaneous quantum job and/or model execution in which a depth of said qubit groups from said separate quantum jobs and/or models of said plurality of quantum jobs and/or models plus a qubit reset time is less than a depth of a longest qubit group of said plurality of quantum jobs and/or models.
